(19) United States
(12) Patent Application Publication
(10) Pub. No.: US 2006/0285739 A1
(43) Pub. Date: Dec. 21, 2006

(54) Evaluation pattern generating method and computer program product

(76) Inventor: Shimon Maeda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/448,719

(22) Filed: Jun. 8, 2006

(30) Foreign Application Priority Data
Jun. 9, 2005 (JP) 2005-169801

(51) Int. Cl. G06K 9/00; G06F 17/50

(52) U.S. Cl. 382/144; 716/19

(57) ABSTRACT

An evaluation pattern generating method includes generating plural types of unit patterns based on a seed pattern group and a unit frame, the seed pattern group including plural types of seed patterns, each of the plural types of unit patterns including a pattern that corresponds to the seed pattern arranged in the unit frame, and generating plural types of evaluation patterns based on the plural types of unit patterns and an arrangement frame having a size that is N times of the unit frame (N is a positive integer), each of the plural types of evaluation patterns including the plural types of evaluation unit patterns arranged in the arrangement frame so that the inside of the arrangement frame is filled with the plural types of the unit patterns.

### CROSS-REFERENCE TO RELATED APPLICATIONS

This application is based upon and claims the benefit of priority from prior Japanese Patent Application No. 2005-169801, filed Jun. 9, 2005, the entire contents of which are incorporated herein by reference.

### BACKGROUND OF THE INVENTION

1. Field of the Invention

The present invention relates to an evaluation pattern generating method and a computer program product used for verification of optical proximity correction (OPC).

2. Description of the Related Art

In recent years, progress of a semiconductor manufacturing technology has been very remarkable, and a semiconductor device having the minimum process dimension of 70 nm has been mass-produced. The miniaturization of the semiconductor device is achieved by a substantial progress of a fine pattern forming technique such as a mask process technique, an optical lithography technique, and an etching technique.

In the days when pattern sizes have been sufficiently large, a pattern nearly same as the design pattern can be formed on the wafer by drawing a plane shape of a desired integrated circuit as a design pattern on a mask pattern, preparing a mask pattern which is faithful to the design pattern, transferring the mask pattern on the wafer by a projective optical system, and etching an underlying layer.

However, as the miniaturization of semiconductor device and integration of integrated circuit increase, forming the pattern faithfully is getting difficult in each process. As a result, the problem that a final finished dimension is not made to be as the same as a design pattern has been brought about.

In order to solve such a problem, correction for modifying a pattern of design data is generally performed so that a desired pattern can be obtained when a pattern formed on a photo mask is transferred onto the wafer (Jpn. Pat. Appln. KOKAI Publication No. 09-186058). Correction of this type is referred to as optical proximity correction (hereinafter, referred to as OPC). A variety of techniques have been proposed and carried out so far.

In the case of using OPC, there is a need for a technique of evaluating the correctness of correction. One method of verifying the correctness of OPC includes a method using an evaluation pattern.

There is no dedicated software (program) for generating an evaluation pattern. Therefore, the evaluation pattern is generated using a general-purpose program language. Verification precision becomes higher as the number of variation of pattern shapes increases. However, the variation of pattern shapes is designed by humans, and thus, it is difficult to easily generate rich pattern variations.

### BRIEF SUMMARY OF THE INVENTION

According to an aspect of the present invention, there is provided an evaluation pattern generating method comprising: generating plural types of unit patterns based on a seed pattern group and a unit frame, the seed pattern group including plural types of seed patterns, each of the plural types of unit patterns including a pattern that corresponds to the seed pattern arranged in the unit frame; and generating plural types of evaluation patterns based on the plural types of unit patterns and an arrangement frame having size that is N times of the unit frame (N is a positive integer), each of the plural types of evaluation patterns including the plural types of evaluation unit patterns arranged in the arrangement frame so that the inside of the arrangement frame is filled with the plural types of the unit patterns.

According to another aspect of the present invention, there is provided a computer program product configured to store program instructions for execution on a computer system enabling the computer system to perform: generating plural types of unit patterns based on a seed pattern group and a unit frame, the seed pattern group including plural types of seed patterns, each of the plural types of unit patterns including a pattern that corresponds to the seed pattern arranged in the unit frame; and generating plural types of evaluation patterns based on the plural types of unit patterns and an arrangement frame having size that is N times of the unit frame (N is a positive integer), each of the plural types of evaluation patterns including the plural types of evaluation unit patterns arranged in the arrangement frame so that the inside of the arrangement frame is filled with the plural types of the unit patterns.

### BRIEF DESCRIPTION OF THE SEVERAL VIEWS OF THE DRAWINGS

FIG. 1 is a flow chart showing a method for generating an evaluation pattern according to the first embodiment;

FIGS. 2A to 2F are views each showing a seed pattern group;

FIGS. 3A to 3H are views each showing an example of another seed pattern group;

FIG. 4 is a view for explaining a method for generating a unit pattern;

FIG. 5 is a view for explaining a method for generating an evaluation pattern;

FIG. 6 is a flow chart showing a method for generating an evaluation pattern according to the second embodiment;

FIGS. 7A to 7D are views each showing a unit pattern generated in units of a drawing grid;

FIG. 8 is a flow chart showing a method for generating an evaluation pattern according to the third embodiment;

FIG. 9 is a view showing an example of evaluation pattern candidates that conform to a design rule;

FIG. 10 is a flow chart showing a method for generating an evaluation pattern according to the fourth embodiment;

FIG. 11 is a flow chart showing a method for generating an evaluation pattern according to the fifth embodiment;

FIG. 12 is a flow chart showing a method for generating an evaluation pattern according to a sixth embodiment;

FIG. 13 is a view for explaining a step of arranging a unit pattern according to the sixth embodiment;

FIG. 14 is a flow chart showing a method for generating an evaluation pattern according to the seventh embodiment;

FIGS. 15A to 15D are views for explaining a step of generating a unit pattern according to the seventh embodiment;

FIG. 16 is a flow chart showing a method for generating an evaluation pattern according to the eighth embodiment;

FIGS. 17A to 17D are views for explaining a step of generating a unit pattern according to the eighth embodiment;

FIG. 18 is a flow chart showing a method for generating an evaluation pattern according to the ninth embodiment;

FIG. 19 is a flow chart showing a method for generating an evaluation pattern according to the tenth embodiment;

FIG. 20 is a flow chart showing a method for generating an evaluation pattern according to the eleventh embodiment;

FIG. 21 is a flow chart showing a method for verifying OPC according to the twelfth embodiment;

FIG. 22 is a flow chart showing a method for verifying OPC of comparative example;

FIG. 23 is a flow chart showing an OPC process using an OPC program according to an embodiment;

FIG. 24 is a flow chart of an OPC process using an OPC program of comparative example;

FIG. 25 is a flow chart showing a method for generating an evaluation pattern of comparative example;

FIGS. 26A to 26C are views each showing an example of a basic pattern; and

FIG. 27 is a view for explaining a computer program product according to an embodiment.

### DETAILED DESCRIPTION OF THE INVENTION

Now, embodiments of the present invention will be described here with reference to the accompanying drawings.

### First Embodiment

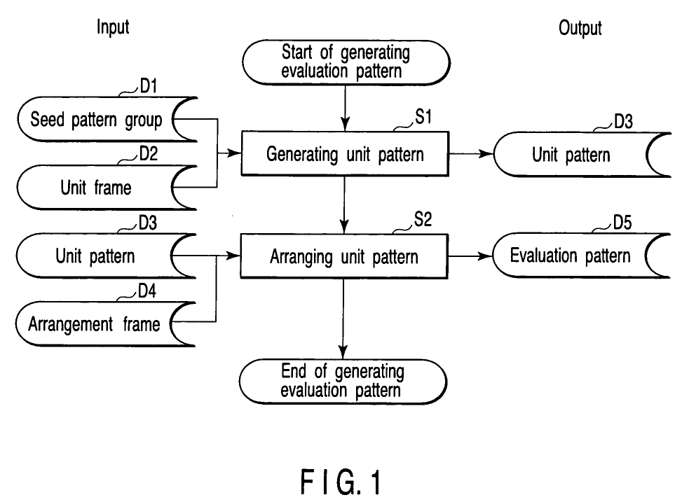

FIG. 1 is a flow chart showing a method for generating an evaluation pattern according to the first embodiment.

First, plural types of unit patterns D3 (output data) are generated using a seed pattern group D1 which includes a plurality of seed patterns, and a unit frame D2 as input data (step S1).

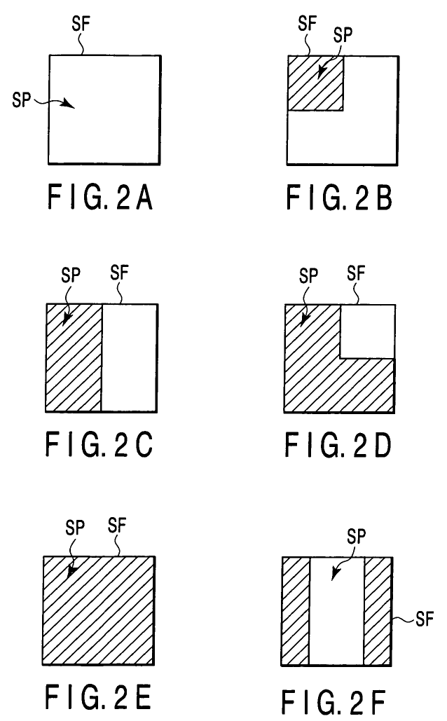

FIGS. 2A to 2F each show an example of seed pattern group D1.

In FIGS. 2A to 2F, SP denotes a seed pattern and SF denotes a seed pattern frame. The seed pattern frame SF is a frame of the seed pattern SP. A white area in the seed pattern frame SF indicates a space, and a shaded area indicates a pattern. Here, the shape of the seed pattern frame SF is a square shape.

FIG. 2A shows a seed pattern SP featured in that the entire inside of a seed pattern frame SF is space. FIG. 2B shows a seed pattern SP featured in that a pattern exists only in an upper left rectangular area in the seed pattern frame SF divided into four sections. FIG. 2C shows a seed pattern SP featured in that a pattern exists only in a left half area in the seed pattern frame SF. FIG. 2D shows a seed pattern SP featured in that a space exists only in an upper right area in the seed pattern frame SF divided into four sections. FIG. 2E shows a seed pattern SP featured in that the entire inside of the seed pattern frame SF is a pattern. In addition, FIG. 2F shows a seed pattern SP featured in that patterns exist in both sides in the seed pattern frame SF.

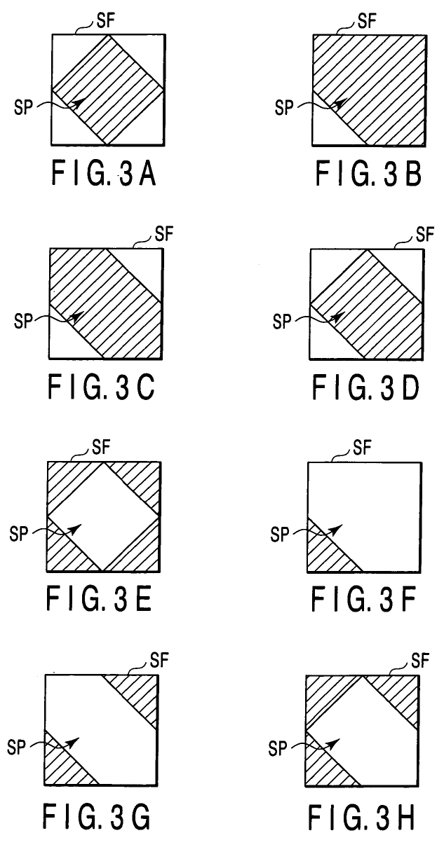

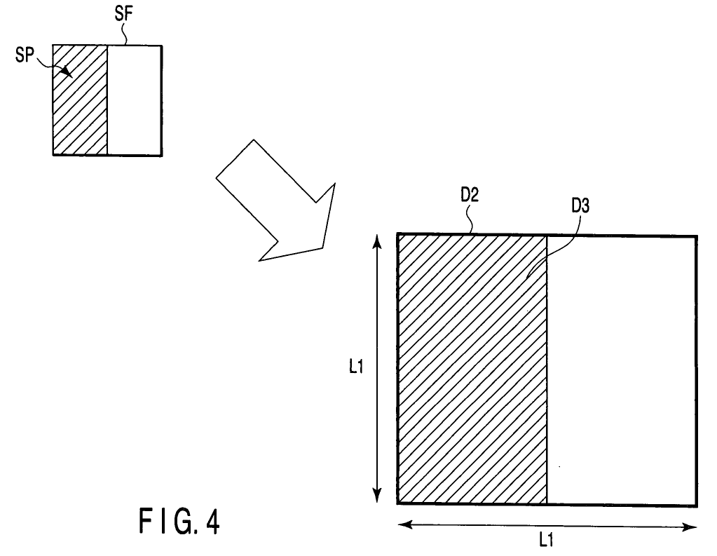

FIGS. 3A to 3H each show an example of another seed pattern group D1. Like FIGS. 2A to 2F, in FIGS. 3A to 3H as well, the seed pattern frame SF is formed in a square shape, a white area in the seed pattern frame SF denotes a space, and a shaded area denotes a pattern.

As shown in FIGS. 2A to 2F and FIGS. 3A to 3H, a pattern having a simple shape is selected for the seed pattern SP. Therefore, the seed pattern SP is easily generated. The seed pattern SP may be generated by either of software (program) and human.

FIG. 4 shows a method for generating plural types of unit patterns D3 from the seed pattern group D1 and the unit frame D2.

Length (unit frame size) L1 of vertical and horizontal sides of the unit frame D2 is such that the vertical and horizontal sides of the seed pattern frame SF are magnified to be equal to each other. The shape of the unit frame D2 is formed in a square. With the magnified vertical and horizontal sides of the seed pattern frame SF, the seed pattern SP is magnified similarly. The thus magnified pattern is provided as the unit pattern D3.

Therefore, a length of one side of the seed pattern frame SF to which the seed pattern SP is specified is magnified (changed) to an extent corresponding to the unit frame size L1, whereby the unit pattern D3 is obtained. For example, in the case where the length of one side of the seed pattern frame SF is L1/4, the length L1/4 of one side of the seed pattern frame SF specified with the seed pattern SP is changed to L (specified size), whereby the unit pattern D3 is obtained. Therefore, plural types of unit patterns D3 is obtained by specifying specified size L and changing length L1/4 to L for each of one side of the seed pattern frames S specified with the seed patterns SP.

Next, a unit pattern is arranged using plural types of unit patterns D3 and arrangement frames D4 for input data (step S2), and plural types of evaluation patterns D5 are generated.

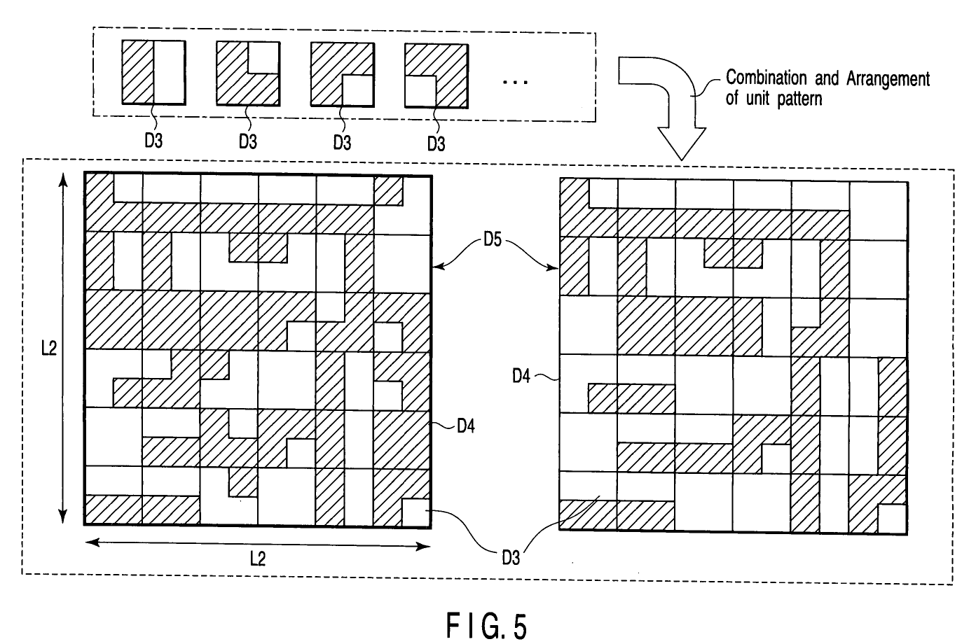

FIG. 5 shows a method for generating the evaluation pattern D5 from the unit pattern D3 and the arrangement frame D4. Two types of evaluation patterns D5 shown in FIG. 5 denote an evaluation pattern for a wiring pattern. The shape of the arrangement frame D4 is a square. In FIG. 5, a length L2 of one side of the arrangement frame D4 is twice as long as an optical radius of OPC, and six types of unit patterns D3 shown in FIGS. 2A to 2F are used.

As shown in FIG. 5, in each evaluation pattern D5, plural types of unit patterns D3 are arranged in the arrangement frame D4 so that the inside of the arrangement frame D4 is filled with plural types of unit patterns D3.

A required number of evaluation patterns D5 can be obtained by changing the arrangement of a plurality of unit patterns D3. Here, all arrangement variations are generated.

A total number M of types of unit patterns D3 is fewer than the number (N) of unit patterns D3 required to configure the evaluation pattern D5 (M<N). Thus, the same type of unit patterns D3 exist in N unit patterns D3 that configure the evaluation patterns D5.

In the case where the total number M of types of unit patterns D3 is greater than or equal to that of unit patterns D3 required to configure the evaluation pattern D5 (M≧N), unit pattern D3 that is not used may be generated.

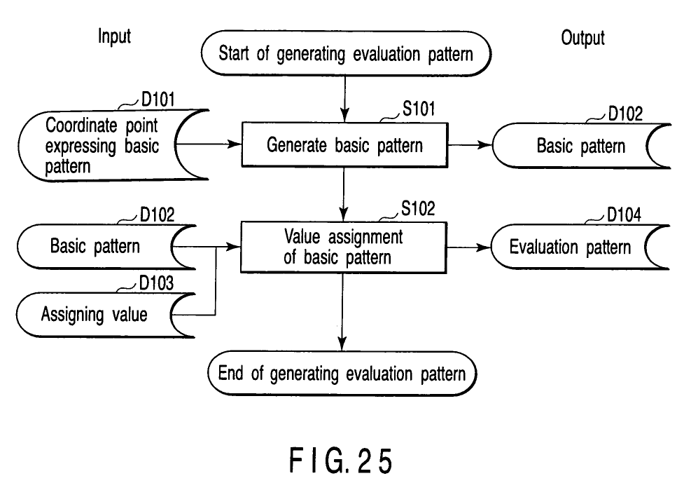

FIG. 25 shows a flow chart of a method for generating an evaluation pattern of comparative example.

First, a basic pattern is generated using coordinate point D101 expressing the basic pattern for input data (step S101), and a basic unit D102 (output data) is generated.

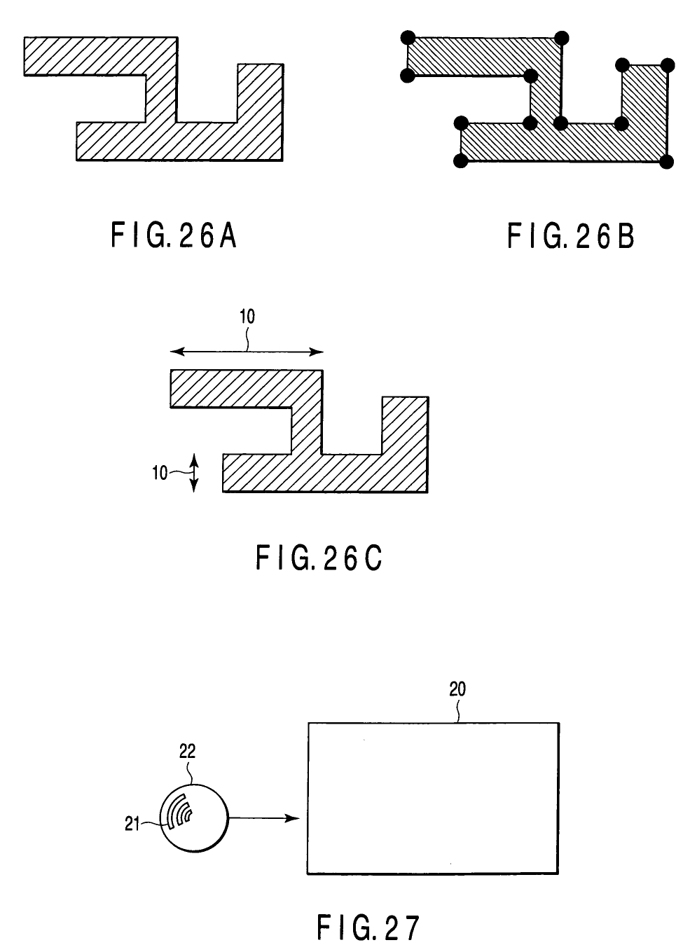

FIG. 26A shows an example of a basic pattern. It is necessary to provide a basic pattern as a pattern that can be written in one stroke. The reason is that a program language used for the method for generating the evaluation pattern of the comparative example is defined in such specification (one-stroke writing). FIG. 26B shows coordinate points (black circles) expressing the basic pattern.

Next, value assigning of the basic pattern is performed by using the portions of the basic pattern (assignment portion) to which values (sizes) are desired to be assigned and its values (assignment values) D103 as input data (step S102), and an evaluation pattern D104 is generated.

FIG. 26C shows an example of an assignment portion 10 in the basic pattern shown in FIG. 26A.

In the case of comparative example, a basic pattern is generated, further, its assignment portion 10 and assignment value are changed, thereby a required number of evaluation patterns are obtained.

There are three problems in comparative example described above.

First, the first problem is that a variation of pattern shapes (basic pattern shape, assignment portion, and assignment value) must be determined on the human side. Therefore, it is difficult to achieve rich pattern variations.

The second problem is that only a pattern that can be realized by one-stroke writing can be handled as a basic pattern. This makes it difficult to achieve rich variations.

The third problem is that it takes long to generate a required number of evaluation patterns. That is, a coordination point must be inputted every time a basic pattern is generated, and it is very cumbersome.

In contrast, in the case of the present embodiment, the seed pattern group D1 having simple shapes and unit frame D2 are merely generated on the software (program) or human side, and thus, the first problem does not occur.

With respect to the second problem, in the case of the present embodiment, a basic pattern as generated in comparative example is not used, and thus, the second problem does not occur. In addition, according to the present embodiment, an evaluation pattern D5 that is not realized by one-stroke writing is also generated as shown in FIG. 5.

In the case of the present embodiment, the steps S1 and S2 are executed by an information processing device such as a computer, whereby plural types of evaluation patterns can be easily generated. Thus, the third problem does not occur.

Therefore, according to the present embodiment, rich pattern variations can be easily generated.

### Second Embodiment

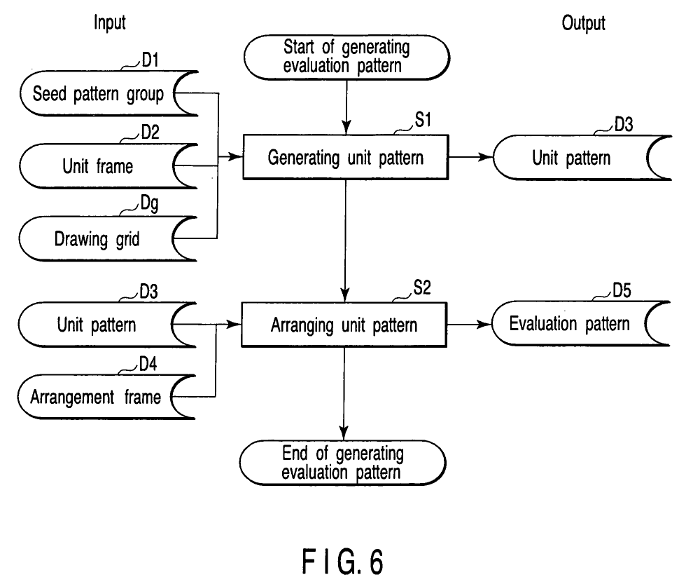

FIG. 6 is a flow chart showing a method for generating an evaluation pattern according to the second embodiment. In the following figures, common parts are denoted by like reference numerals, and a detailed description is omitted.

The present embodiment is different from the first embodiment in that a drawing grid (design grid) Dg is used as input data for generating the unit pattern (step S1) in addition to the seed pattern group D1 and unit frame D2 (step S1).

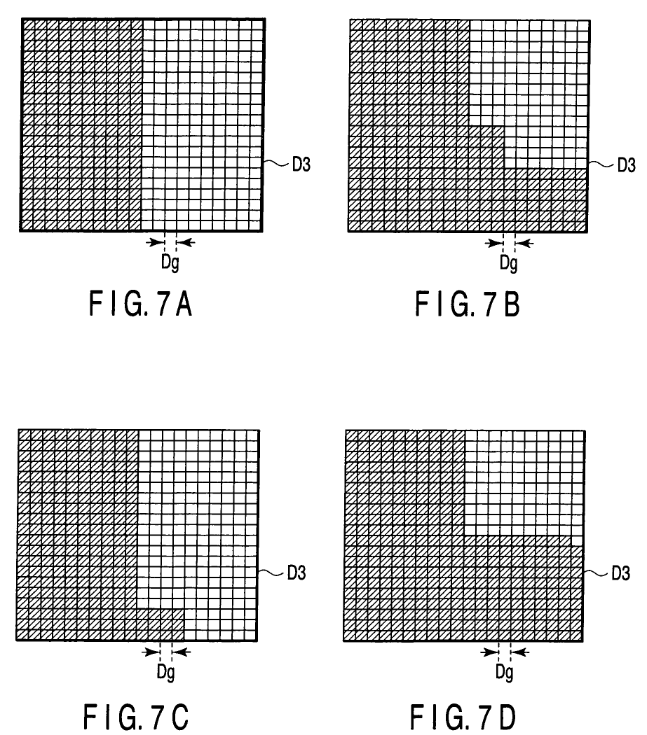

Therefore, a unit pattern D3 is generated in units of drawing grid Dg, as shown in FIGS. 7A to 7D. Pattern variations are increased by selecting drawing grids Dg as units of the unit pattern D3.

In the present embodiment as well, an advantageous effect similar to that of the first embodiment can be obtained. Further, according to the present embodiment, an evaluation pattern covering all variations required for verification of OPC can be generated, as a result, it becomes possible to completely eliminate middle scale or large scale data verification that is operated in the OPC verification method of comparative example. This OPC verification method will be described in more detail in a twelfth embodiment.

### Third Embodiment

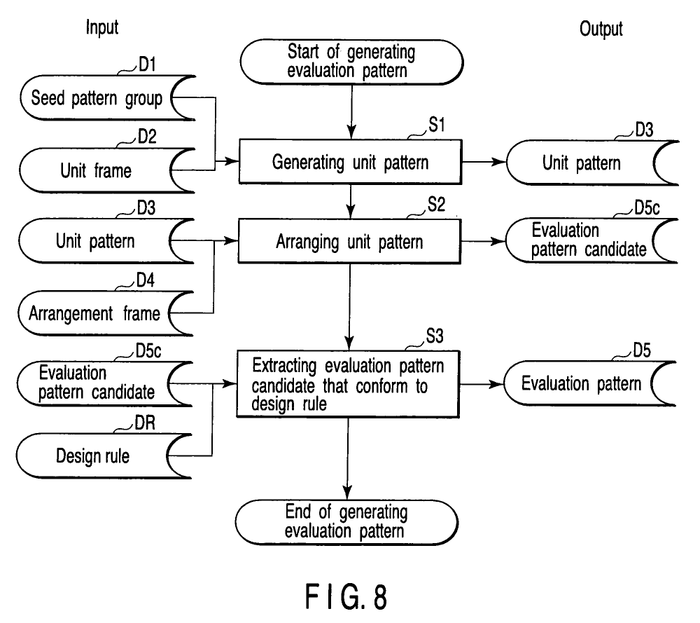

FIG. 8 is a flow chart showing a method for generating an evaluation pattern according to the third embodiment.

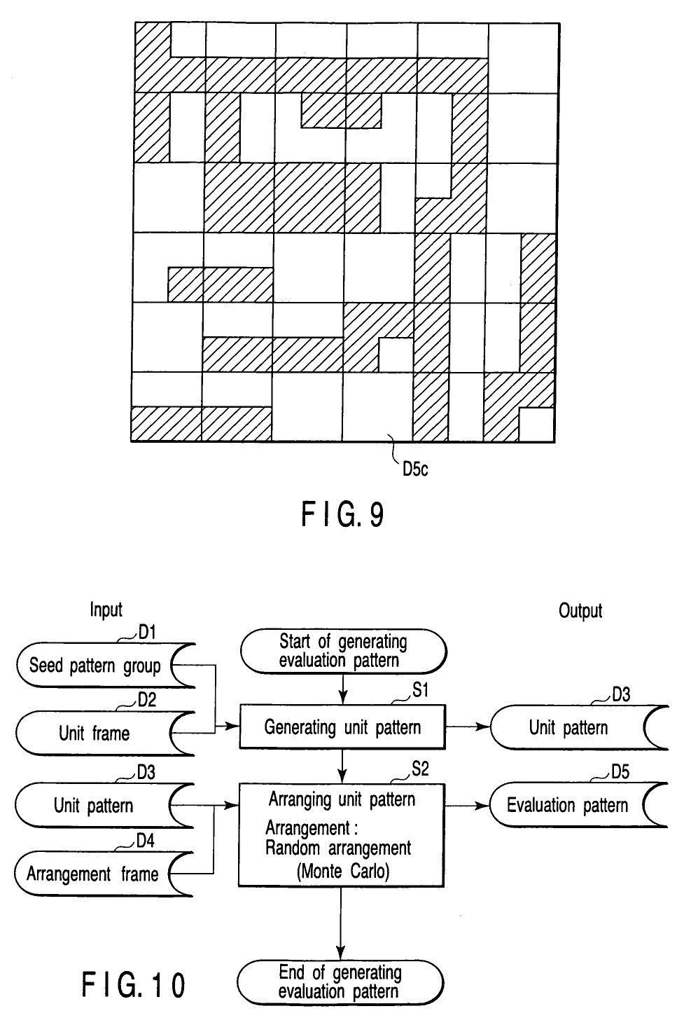

In the present embodiment, a plurality of evaluation patterns generated in the step of arranging a unit pattern (step S2) is defined as evaluation pattern candidates D5c, respectively. These evaluation pattern candidates D5c are checked by design rule check using a design rule DR, and every pattern candidate D5c conforming to the design rule is extracted (step S3). The every extracted evaluation pattern candidate D5c is defined as evaluation pattern D5. FIG. 9 shows an example of evaluation pattern candidate D5c which is checked by design rule check and conforms to the design rule, i.e., an example of evaluation pattern.

According to the present embodiment, in addition to an advantageous effect similar to that of the first embodiment, there can be attained an advantageous effect that the number of evaluation patterns that could be increased sharply can be restricted.

### Fourth Embodiment

FIG. 10 is a flow chart showing a method for generating an evaluation pattern according to the fourth embodiment.

The present embodiment is different from the first embodiment in that, in the step of arranging the unit pattern (step S2), a unit pattern D3 is arranged randomly instead of generating all arrangement variations. As a method for arranging the unit pattern D3 randomly, a method using Monte Carlo method is given for instance.

According to the present embodiment, in addition to the advantageous effect similar to that of the first embodiment, there can be attained an advantageous effect that the number of evaluation patterns that could be increased sharply can be restricted to a realistic number.

Instead of arranging the unit pattern D3 randomly by using Monte Carlo method, the unit pattern D3 may be arranged by changing a probability of generating the unit pattern D3.

In the case of using the Monte Carlo method, the probabilities of generating the unit pattern D3 that corresponds to the seed pattern group D1 shown in FIGS. 2A to 2F are all set to ⅙, however, for example, the probability of generating the unit pattern D3 that corresponds to the seed pattern group D1 shown in FIG. 2A may be set to ½, and the other probabilities may be set to 1/12.

Such an arrangement method can be carried out by making correction so that a probability of generating a certain unit pattern D3 is different from that of another unit pattern D3 in Monte Carlo method.

### Fifth Embodiment

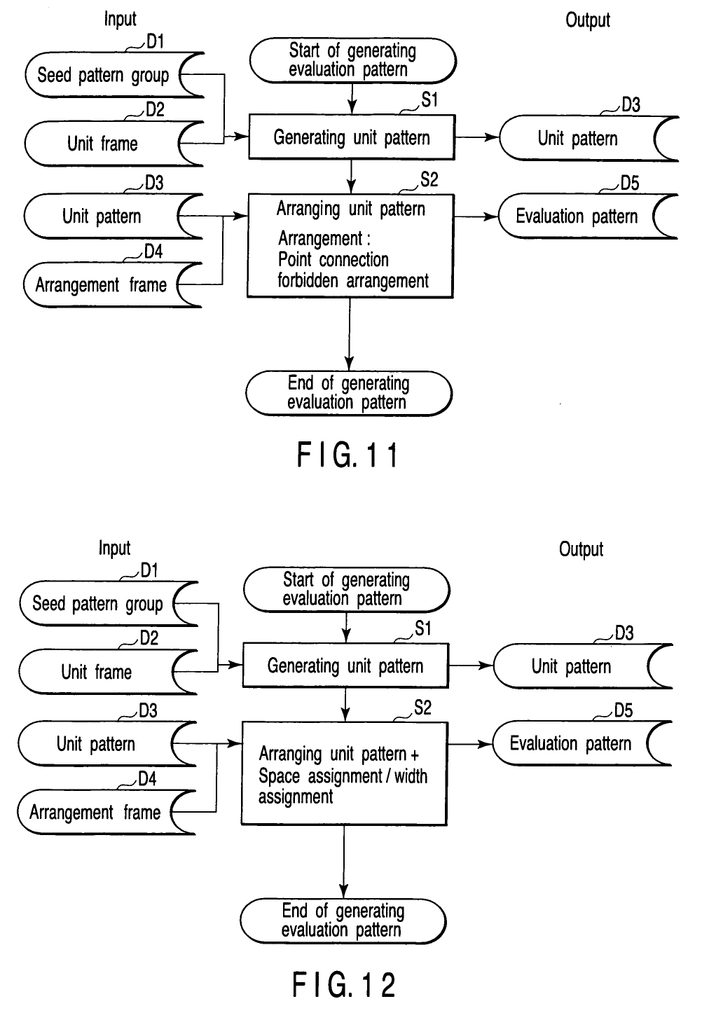

FIG. 11 is a flow chart showing a method for generating an evaluation pattern according to the fifth embodiment.

The present embodiment is different from the first embodiment in that, in the step of arranging the unit pattern (step S2), an arrangement variation is generated so that a portion connected at a point does not occur between unit patterns D3 connected to each other.

According to the present embodiment, an advantageous effect similar to that of the first embodiment can be attained. Further, according to the present embodiment, there can be attained an advantageous effect that the number of evaluation patterns that could be increased sharply can be restricted to a realistic number by forbidding (disabling) point connection and arranging the unit pattern D3. Further, there is a high possibility that point connection portions cannot be realized on a wafer, and thus, there is no need for generating a wasteful evaluation pattern.

### Sixth Embodiment

FIG. 12 is a flow chart showing a method for generating an evaluation pattern according to the sixth embodiment.

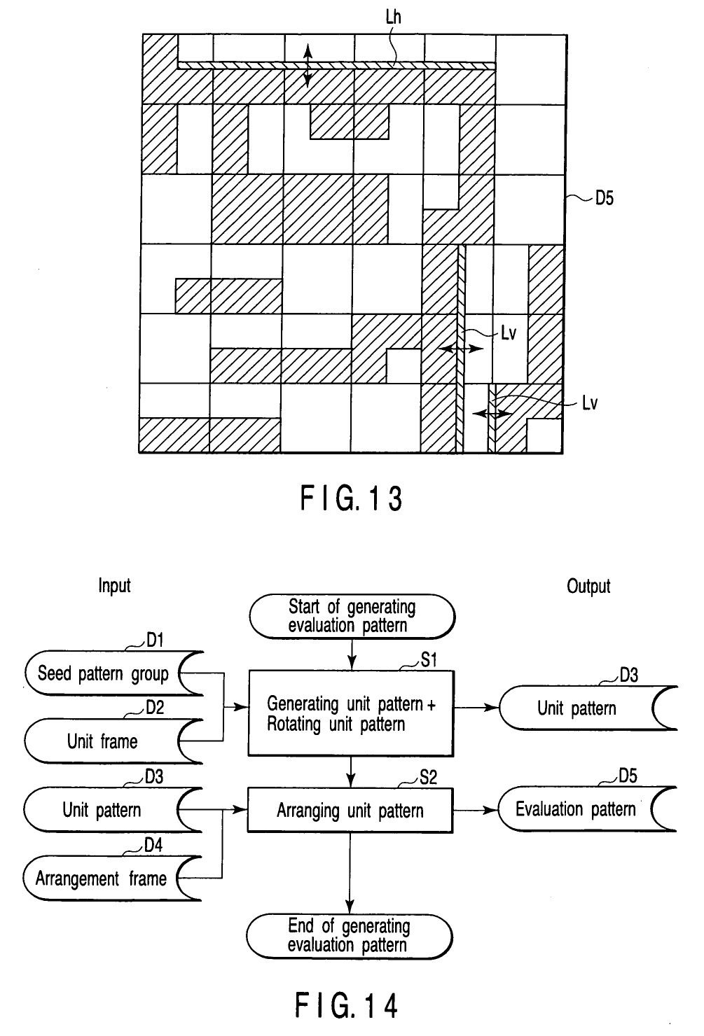

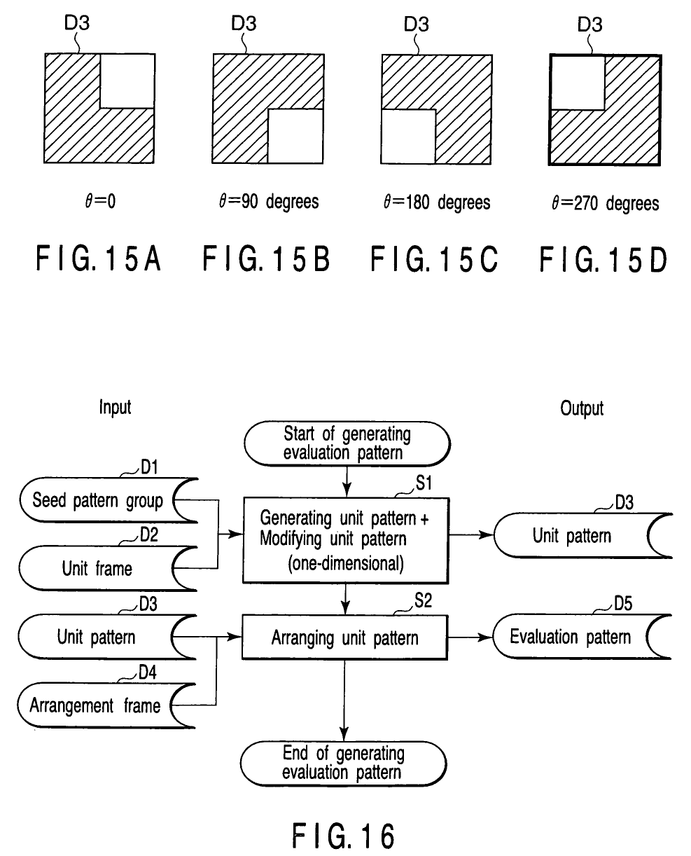

The present embodiment is different from the first embodiment in that the step of the arranging the unit pattern (step S2) includes a step of assigning a space width value or a line width value by moving upwardly or downwardly a boundary (horizontal line) Lh between a space and a pattern, or moving to the right or left a boundary (vertical line) Lv between a space and a pattern as shown in FIG. 13 after the arranging the unit pattern D3, and a step of adding a pattern obtained by assigning a space width value or a line width value to the evaluation pattern D5.

According to the present embodiment, an advantageous effect similar to that of the first embodiment can be attained. Further, according to the present embodiment, it becomes possible to make richer variations of evaluation patterns by using the pattern obtained by assigning the space width value or the line width value as the evaluation pattern D5.

### Seventh Embodiment

FIG. 14 is a flow chart showing a method for generating an evaluation pattern according to the seventh embodiment.

The present embodiment is different from the first embodiment in that the step of the arranging the unit pattern (step S2) includes a step of rotating the generated unit pattern D3 (rotation angle θ=0 degree) (by 90 degrees, 180 degrees, and 270 degrees) as shown in FIGS. after the generating the unit pattern D3. 15A to 15D, and a step of adding a pattern obtained by rotating the unit pattern D3 to the unit pattern D3.

According to the present embodiment, an advantageous effect similar to that of the first embodiment is attained. Further, according to the present embodiment, the pattern obtained by rotating the unit pattern D3 is utilized as the unit pattern D3, thereby making it possible to efficiently increase variations of evaluation patterns.

### Eighth Embodiment

FIG. 16 is a flow chart showing a method for generating an evaluation pattern according to the eighth embodiment.

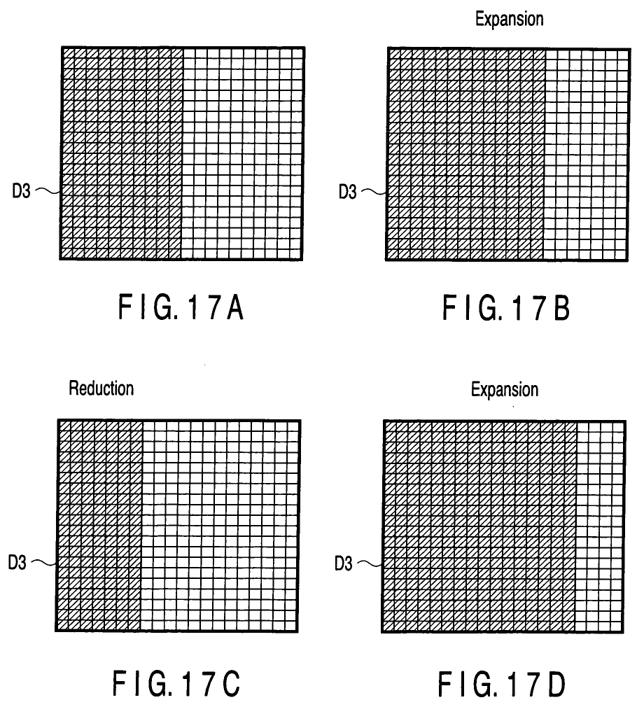

The present embodiment is different from the second embodiment in that the step of arranging a unit pattern (step S2) includes a step of expanding or reducing the generated unit pattern D3 in one direction as shown in FIGS. 17A to 17D after the generating the unit pattern D3, and a step of adding a pattern obtained by expanding or reducing this unit pattern D3 in one direction to the unit pattern D3.

According to the present embodiment, an advantageous effect similar to that of the second embodiment is attained. Further, according to the present embodiment, only the pattern obtained by expanding or reducing the unit pattern D3 in one direction is utilized as the unit pattern D3, thereby making it possible to efficiently restrict an increasing number of evaluation patterns.

### Ninth Embodiment

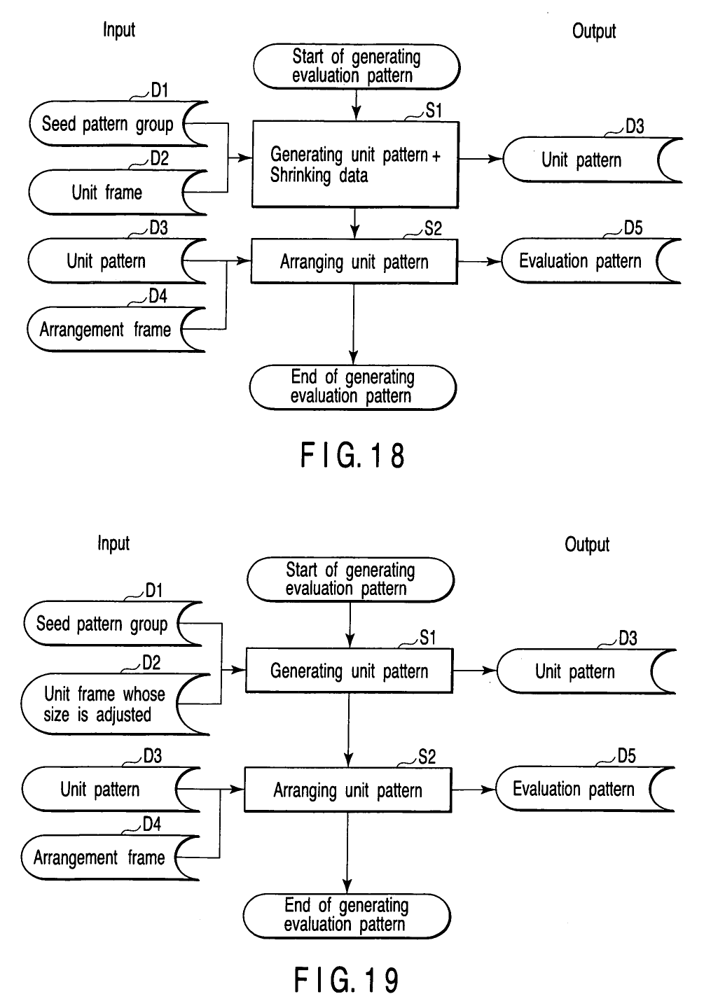

FIG. 18 is a flow chart showing a method for generating an evaluation pattern according to the ninth embodiment.

The present embodiment is different from the first embodiment in that the step of the generating the unit pattern (step S1) includes a step of shrinking the generated unit pattern D3 after the generating the unit pattern D3, and a step of adding the shrunk unit pattern D3 to the unit pattern D3. The above described shrinking denotes converting a pattern of one generation to a finer generation pattern in accordance with scaling rule.

According to the present embodiment, an advantageous effect similar to that of the first embodiment is attained. Further, according to the present embodiment, a pattern obtained by shrinking the unit pattern D3 is also utilized as the unit pattern D3, thereby evaluation patterns of their different generations are obtained, thus making it possible to increase richer variations of the evaluation patterns.

### Tenth Embodiment

FIG. 10 is a flow chat showing a method for generating an evaluation pattern according to the tenth embodiment.

The present embodiment is different from the first embodiment in that a unit frame which is obtained by adjusting size of unit frame (unit frame size L) prepared beforehand (the unit frame D2 shown in FIG. 1) is used as a unit frame D2.

According to the present embodiment, an advantageous effect similar to that of the first embodiment is attained. Further, according to the present embodiment, a unit frame whose size is adjusted to be larger is used, thereby making it possible to restrict increasing number of evaluation patterns. In contrast, a unit frame whose size is adjusted to be smaller is used, thereby making it possible to increase the variations of evaluation patterns.

There is no need for preparing the unit frame whose size is adjusted if a step of adjusting the size of unit frame prepared beforehand (unit frame D2 shown in FIG. 1) is added.

### Eleventh Embodiment

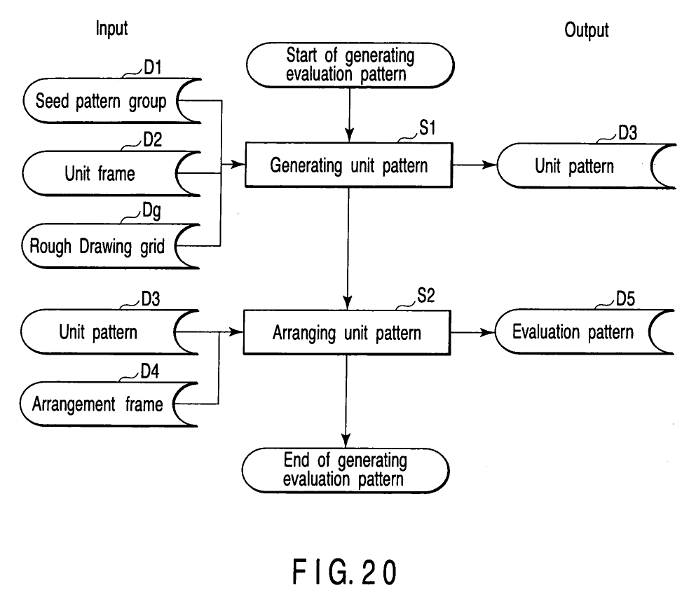

FIG. 20 is a flow chart showing a method for generating an evaluation pattern according to the eleventh embodiment.

The present embodiment is different from the second embodiment in that an increasing number of evaluation patterns are restricted by roughening a drawing grid Dg.

### Twelfth Embodiment

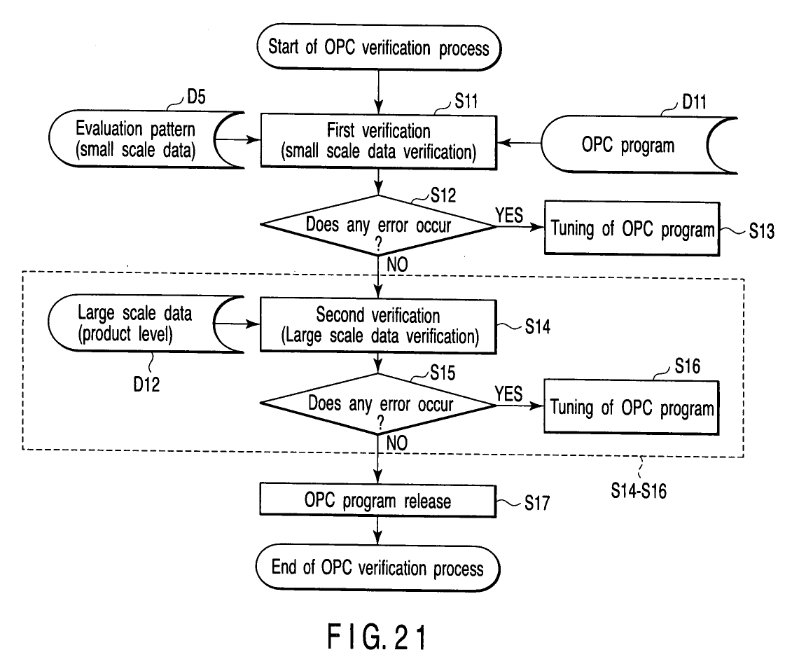

FIG. 21 is a flow chart showing an OPC verification method according to the twelfth embodiment.

First, the first verification of an OPC program is made by verification program for verifying the OPC program using an evaluation pattern (small scale data) D5 generated by any of the methods according to the first to eleventh embodiments and an OPC program D11 targeted for the verification as input data (step S11). The first verification (step S11) corresponds to a small scale data verification of comparative example described later.

Next, it is judged whether or not an error occurs with the OPC program, based on a result of the first verification (step S12).

In the case where the error occurs, tuning of the OPC program D11 is carried out (step S13). Thereafter, the first verification is made again. A looping of the steps S11 to S13 ends, for example, if the number of the loop reaches a predetermined number, for preventing the loop from being an indefinite loop.

In the case where no error occurs, the second verification of the OPC program is made by verification program for verifying the OPC program using actual product design pattern data (large scale data) D12 as input data (step S14). The second verification (step S14) corresponds to a large scale data verification of comparative example, described later.

A data quantity of the design pattern data D12 is larger than a data quantity of the evaluation pattern D5 in general. Here, in the case of the present embodiment, pattern variations of the evaluation patterns D5 are rich, thus making it possible to eliminate the second verification (step S14). That is, the evaluation pattern D5 may include data used in the second verification (step S14).

Next, it is judged whether or not an error occurs with the OPC program based on a result of the second verification (step S15).

In the case where an error occurs, tuning of the OPC program D11 is carried out (step S16). Thereafter, the first verification is carried out again. A loop of the steps S14 to S16 ends, for example, if the number of the loop reaches a predetermined number.

In the case where no error occurs, the OPC program is accepted as the one that can be released as an actual product (step S17).

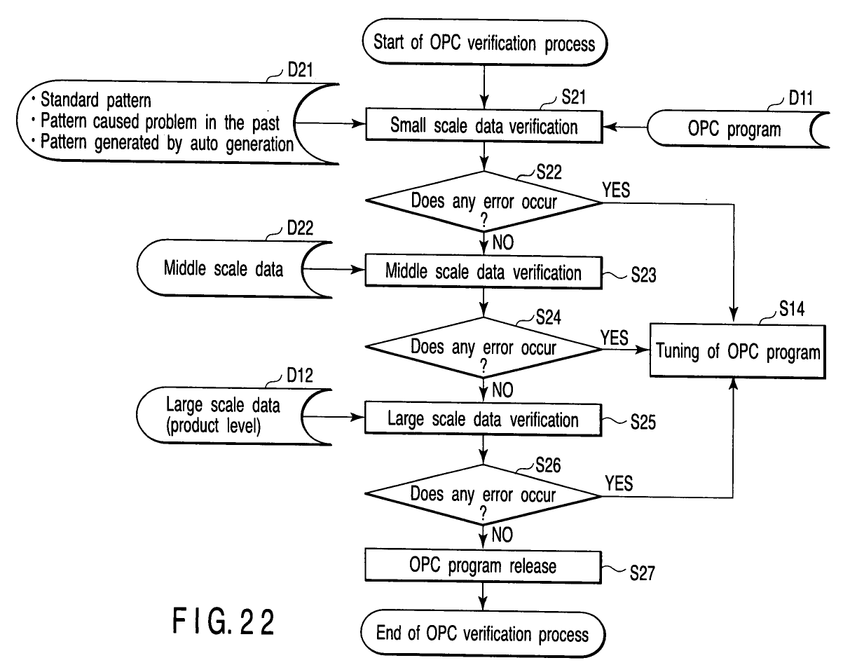

FIG. 22 is a flow chart showing an OPC verification method of comparative example.

The OPC verification method of comparative example has three verification steps (small scale data check S21, middle scale data check S23, and large scale data check S25) and three judging steps S22, S24, and S26.

In contrast, in the case of the present embodiment, a maximum of two verification steps S11 and S14 and two judging steps S12 and S15 will suffice. Therefore, according to the present embodiment, as compared with comparative example, the OPC verification can be made in a shorter period of time.

In the OPC verification method of comparative example, there is a need for preparing a standard pattern, a pattern which caused a problem in the past, and a pattern generated by auto generation as small scale data D21. Further, in the case of comparative example, there is a need for preparing middle scale data D22 that is not used in the present embodiment. Therefore, in comparative example, it takes long to prepare OPC verification data. In contrast, in the case of the present embodiment, there is no need for the middle scale data D22. In addition, the evaluation pattern D5 corresponding to the small scale data D21 can be easily generated. Thus, it does not take long for preparing data compared to comparative example.

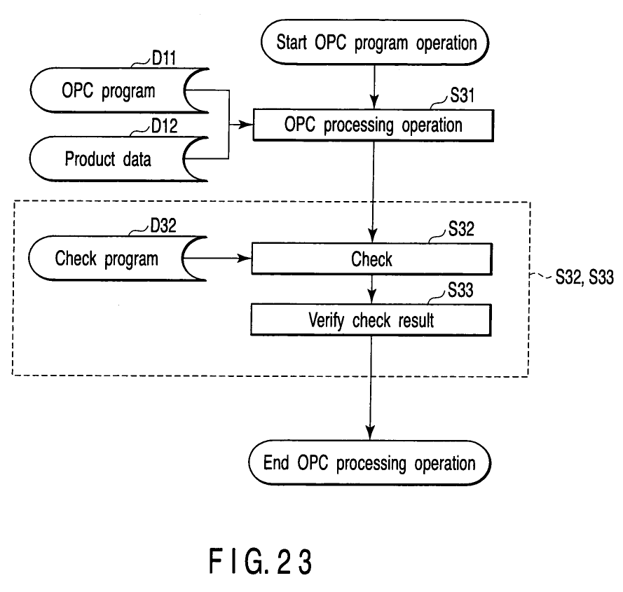

FIG. 23 is a flow chart showing an OPC process using an OPC program judged error free by OPC verification method of the present embodiment.

An OPC process (step S31) is made using the OPC program D11 and product design pattern data D12. Confirmation and verification of the OPC process (steps S32 and S33) are made using a verification program D32 as required.

The OPC program D11 of the present embodiment is generated using the evaluation pattern D5 having rich pattern variations. Thus, it is presumed that the evaluation pattern D5 of the embodiment includes a variety of patterns (additional pattern and modified pattern) generated in the OPC process. Therefore, the OPC process of the present embodiment basically does not require the confirmation and verification (steps S32 and S33).

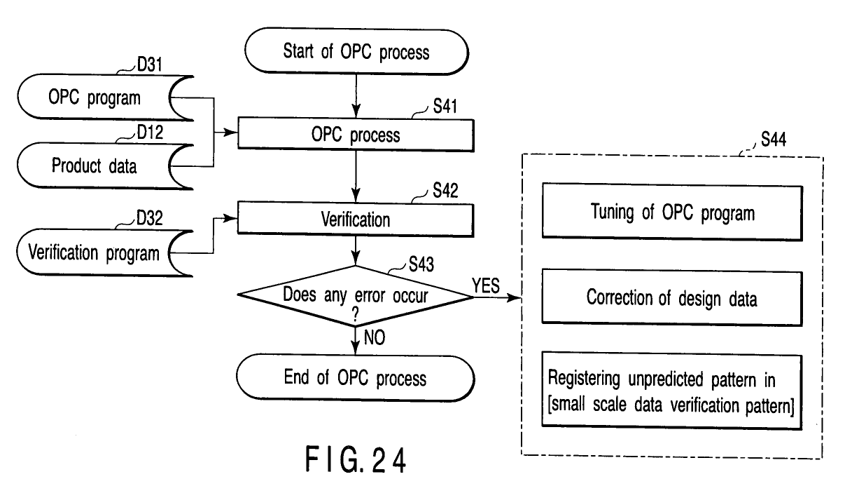

FIG. 24 is a flow chart showing an OPC process using an OPC program judged error free by OPC verification method of the comparative example.

The OPC process is made using an OPC program D31 and the product design pattern data D12 (step S41).

Next, verification of the OPC process is made using the verification program D32 (step S42).

As a result of the check, in the case where an error occurs in the OPC process, tuning of the OPC program and correction of design data are made, and further, a pattern proved to error (unpredicted pattern) is registered as a small scale verification pattern (step S44).

The OPC program D31 of comparative example is generated using an evaluation pattern that lacks a pattern variation. Thus, there is no guarantee that the evaluation pattern of comparative example includes a pattern (additional pattern or modified pattern) generated in the OPC process. Therefore, there is a need for verifying the OPC process of comparative example.

A method for generating an evaluation pattern of the embodiment described above can be carried out as a computer program product (for example, CD-ROM or DVD) 22 having recorded therein a program 21 to be executed by a system including a computer 20, as shown in FIG. 27.

For example, a computer program product of the method for generating the evaluation pattern of the embodiment causes a computer to execute the step (instruction) that includes the step (instruction) corresponding to the steps S1 and S2 or the steps S1 to S3 of the embodiment described above.

The program in the computer program product is executed using hardware resources, such as a CPU and memory in the computer (external memory may be concurrently used depending on the case). The CPU reads necessary data from the memory, and executes instructions corresponding to the steps described above for the read data. The result of the respective step (execution of the respective instruction) is temporarily stored by necessary in the memory, and is read out when it is required in the other step (instruction).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An evaluation pattern generating method comprising:
generating plural types of unit patterns based on a seed pattern group and a unit frame, the seed pattern group including plural types of seed patterns, each of the plural types of unit patterns including a pattern that corresponds to the seed pattern arranged in the unit frame; and
generating plural types of evaluation patterns based on the plural types of unit patterns and an arrangement frame having a size that is N times of the unit frame (N is a positive integer), each of the plural types of evaluation patterns including the plural types of evaluation unit patterns arranged in the arrangement frame so that the inside of the arrangement frame is filled with the plural types of the unit patterns.

2. The evaluation pattern generating method according to claim 1, wherein the generating the plural types of unit patterns includes generating plural types of unit patterns which conform to a drawing grid using the drawing grid in addition to the seed pattern group and the unit frame.

3. The evaluation pattern generating method according to claim 1, wherein the generating the plural types of unit patterns includes generating plural types of unit patterns which conform to a design rule using the design rule in addition to the seed pattern group and the unit frame.

4. The evaluation pattern generating method according to claim 1, wherein the generating the plural types of evaluation patterns includes arranging randomly the plural types of evaluation unit patterns in the arrangement frame by Monte Carlo method.

5. The evaluation pattern generating method according to claim 1, further comprising: extracting an evaluation pattern adapted to a design rule from the plural types of evaluation patterns, and using the extracted evaluation pattern as an evaluation pattern.

6. The evaluation pattern generating method according to claim 1, further comprising: adding a pattern obtained by moving a boundary between a space and a pattern in the evaluation pattern to the plurality of evaluation patterns.

7. The evaluation pattern generating method according to claim 1, further comprising: adding a pattern obtained by rotating the unit pattern to the plural types of unit patterns.

8. The evaluation pattern generating method according to claim 1, further comprising: adding a pattern obtained by expanding or reducing the unit pattern in one direction to the plural types of unit patterns.

9. The evaluation pattern generating method according to claim 1, further comprising adding a pattern obtained by shrinking the unit pattern to the plurality of unit patterns.

10. The evaluation pattern generating method according to claim 1, wherein the unit frame is obtained by adjusting size of a unit frame which is prepared beforehand.

11. A computer program product configured to store program instructions for execution on a computer system enabling the computer system to perform:
generating plural types of unit patterns based on a seed pattern group and a unit frame, the seed pattern group including plural types of seed patterns, each of the plural types of unit patterns including a pattern that corresponds to the seed pattern arranged in the unit frame; and
generating plural types of evaluation patterns based on the plural types of unit patterns and an arrangement frame having size that is N times of the unit frame (N is a positive integer), each of the plural types of evaluation patterns including the plural types of evaluation unit patterns arranged in the arrangement frame so that the inside of the arrangement frame is filled with the plural types of the unit patterns.
